(19) United States
(12) Patent Application Publication
(10) Pub. No.: US 2017/0039293 A1
(43) Pub. Date: Feb. 9, 2017

(54) QUESTION ANSWERING SYSTEM WITH DATA MINING CAPABILITIES

(71) Applicants: Krishna Kummamuru, Bangalore (IN); Abhishek Shivkumar, London (GB)

(72) Inventors: Krishna Kummamuru, Bangalore (IN); Abhishek Shivkumar, London (GB)

(21) Appl. No.: 14/817,534

(22) Filed: Aug. 4, 2015

(51) Int. Cl. G06F 17/30

(52) U.S. Cl. CPC G06F 17/30914; G06F 17/30958; G06F 17/30424

(57) ABSTRACT

A question is received. The question is in a natural language. The question is mapped to a data mining model. A query associated with the question is determined. The query is related to the data mining model. The query is executed on a dataset of structure data.

### TECHNICAL FIELD

The present invention relates generally to the field of question answering systems, and more particularly to a question answering system with data mining capabilities.

### BACKGROUND OF THE INVENTION

Question answering is a computer science discipline related to the fields of information retrieval and natural language processing. Question answering systems automatically answer questions from humans asked in a natural language. The question answering systems can cover both closed-domain questions, dealing with questions under a specific domain or subject area, or open-domain questions, dealing with questions in nearly anything. Question answering systems have been extended and expanded recently to cover many domains involving large amounts of knowledge. For example, systems have been developed to automatically answer temporal and geospatial questions, questions of definition and terminology, biographical questions, multilingual questions, and questions about the content of audio, images, and video. Question answering systems are very dependent on a good search corpus. A corpus is a large set of texts, usually electronically stored and processed, that are used to do statistical analysis and hypothesis testing.

Unstructured data usually references information that isn't stored in a traditional row-column database. Unstructured data often includes text and multimedia content. For example, unstructured data can be e-mail messages, word processing documents, videos, photos, audio files, and the like.

Structured data usually references data that is stored in a fixed field within a record or file. Structured data depends on creating a data model. The data model includes the types of data that will be recorded and how that data will be stored, processed, and accessed. This may include defining the fields that data will be stored. For example the data type (i.e. numeric, currency, alphabetic, name, data, address, etc.). This may also include defining how the data will be stored. For example, any restrictions on the data input (i.e. Mr., Mrs., or Dr; M or F; etc.)

### SUMMARY

Embodiments of the present invention include a method, computer program product, and system for question answering with data mining capabilities. In one embodiment, a question is received. The question is in a natural language. The question is mapped to a data mining model. A query associated with the question is determined. The query is related to the data mining model. The query is executed on a dataset of structure data.

### BRIEF DESCRIPTION OF THE DRAWINGS

FIG. 1 is a functional block diagram of a data processing environment, in accordance with an embodiment of the present invention;

FIG. 2 is a flowchart depicting operational steps for question answering with data mining capabilities, in accordance with an embodiment of the present invention; and

FIG. 3 depicts a block diagram of components of the computer of FIG. 1, in accordance with an embodiment of the present invention.

### DETAILED DESCRIPTION

Embodiments of the present invention are able to receive a question and determine the attributes of the question to pass on to a query that is input to a data mining model and used to determine an answer to the question. Embodiments of the present invention determine the type of data mining operations involved with the question.

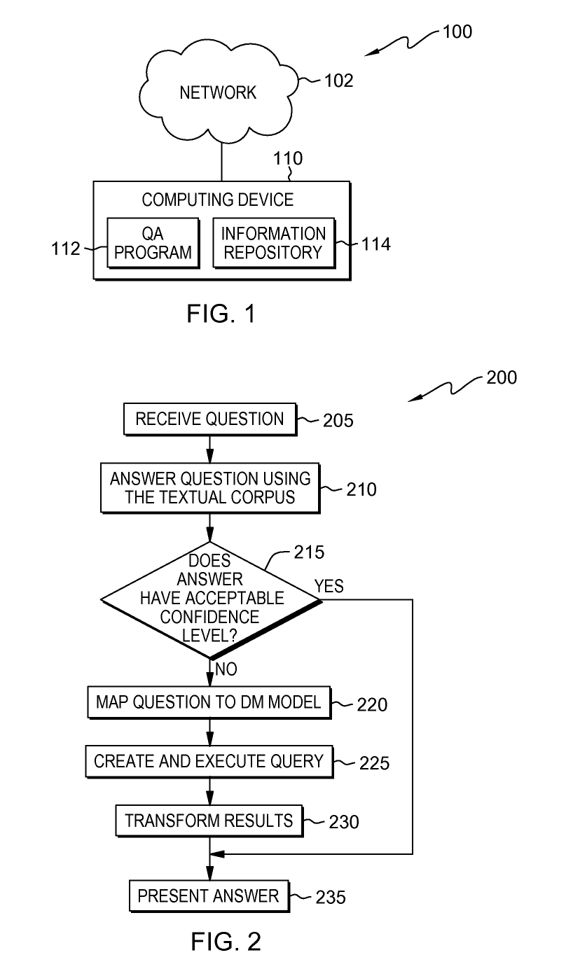

The present invention will now be described in detail with reference to the Figures. FIG. 1 is a functional block diagram illustrating a data processing environment, generally designated 100, in accordance with one embodiment of the present invention. FIG. 1 provides only an illustration of one implementation and does not imply any limitations with regard to the systems and environments in which different embodiments can be implemented. Many modifications to the depicted embodiment can be made by those skilled in the art without departing from the scope of the invention as recited by the claims.

An embodiment of data processing environment 100 includes computing device 110, connected to network 102. Network 102 can be, for example, a local area network (LAN), a telecommunications network, a wide area network (WAN) such as the Internet, or any combination of the three, and include wired, wireless, or fiber optic connections. In general, network 102 can be any combination of connections and protocols that will support communications between computing device 110 and any other computer connected to network 102, in accordance with embodiments of the present invention.

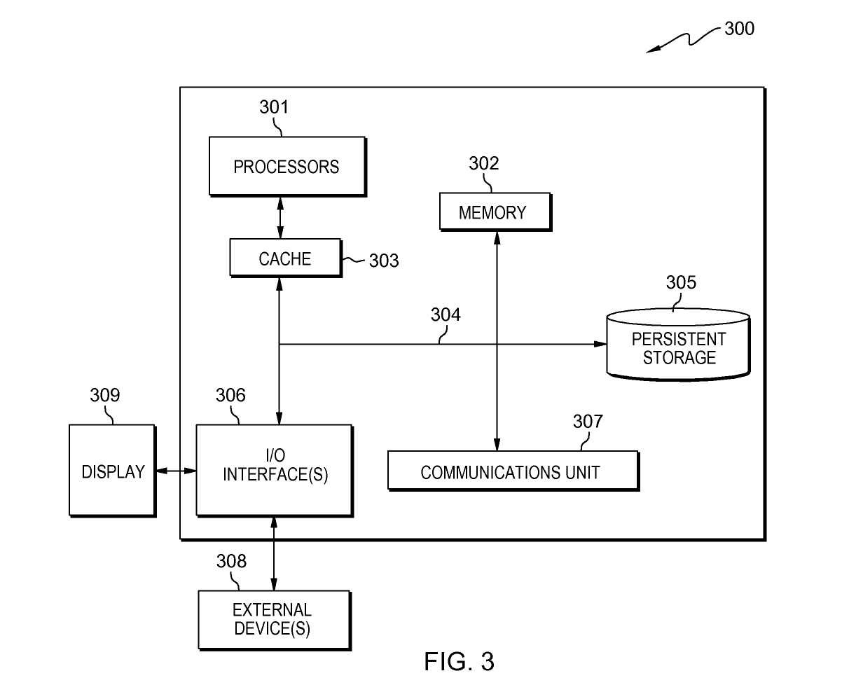

In example embodiments, computing device 110 can be a laptop, tablet, or netbook personal computer (PC), a desktop computer, a personal digital assistant (PDA), a smart phone, or any programmable electronic device capable of communicating with any computing device within data processing environment 100. In certain embodiments, computing device 110 collectively represents a computer system utilizing clustered computers and components (e.g., database server computers, application server computers, etc.) that act as a single pool of seamless resources when accessed by elements of data processing environment 100, such as in a cloud computing environment. In general, computing device 110 is representative of any electronic device or combination of electronic devices capable of executing computer readable program instructions. Computing device 110 can include components as depicted and described in further detail with respect to FIG. 3, in accordance with embodiments of the present invention.

Computing device 110 includes question answering (QA) program 112 and information repository 114. QA program 112 is a program, application, or subprogram of a larger program for question answering using natural language processing that includes data mining capabilities. Information repository 114 may include a textual corpus, structured data, knowledge bases, and information regarding data mining operations.

In an embodiment, QA program 112 receives a question from a user. QA program 112 answers the question using the textual corpus and then determines if the answer is above a threshold. If the answer is above a threshold, QA program 112 presents the answer to the user. If the answer is not above a threshold, QA program 112 maps the question to a data mining model. QA program 112 creates a query based on the data mining model and then executes the query using the mapped data mining model. QA program 112 receives the results of the query, transforms them into a form that answers the question of the user and then presents the answer to the user.

A user interface (not shown) is a program that provides an interface between a user and QA program 112. A user interface refers to the information (such as graphic, text, and sound) a program presents to a user and the control sequences the user employs to control the program. There are many types of user interfaces. In one embodiment, the user interface can be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computer, GUIs were introduced in reaction to the perceived steep learning curve of command-line interfaces, which required commands to be typed on the keyboard. The actions in GUIs are often performed through direct manipulation of the graphics elements.

In an embodiment, computing device 110 includes information repository 114. In an embodiment, information repository 114 may be found on computing device 110. In an alternative embodiment, information repository 114 may be found on one or more device (not shown) interconnected to computing device 110 via network 102. In yet another embodiment, information repository 114 may be on computing device 110 and any other number of devices interconnected to computing device 110 via network 102.

In an embodiment, a textual corpus may include various types of textual material. Generally, the textual corpus is unstructured data. For example, the textual corpus may include web pages, documents from an enterprise, e-mails etc. In an embodiment, a user may indicate the textual corpus that QA program 112 will access to answer questions. In an alternative embodiment, another program (not shown) will indicate the textual corpus that QA program 112 will access to answer questions. In yet another alternative embodiment, QA program 112 may access network 102 and use any unstructured data found on other devices (not shown) to answer questions. For example, QA program 112 may access the World Wide Web (i.e. textual corpus) and search or view websites and pictures, documents, text, etc., on websites to answer questions.

In an embodiment, structured data may include any data that resides in a fixed field within a record or file. This may include data contained in relational databases and spreadsheets. In an embodiment, a user may indicate the structured database that QA program 112 will access to answer questions. In an alternative embodiment, another program (not shown) will indicate the structured database that QA program 112 will access to answer questions. In yet another alternative embodiment, QA program 112 may access network 102 and use any structured data found on other devices (not shown) answer questions. For example, QA program 112 may access the World Wide Web and search or view websites to find structured data to answer questions. The structured data may be private data (i.e. a company) or public data (i.e. a crowd-sourced community). In an embodiment, the structured data may be stored in raw files on file systems formats (i.e., CSV (Comma Separated Values), etc.) or in database systems found on local or remote systems. In an embodiment, the structured data may include content indexes describing the structured data that may be found locally, remotely, or offline from the structure data.

In an embodiment, the knowledge base may include data that assist in the mapping of relations of words. In an embodiment, the knowledge base may include a dictionary, encyclopedia or a thesaurus. In an embodiment, a user may indicate the knowledge base that QA program 112 will access to answer questions. In an alternative embodiment, another program (not shown) will indicate the knowledge base that QA program 112 will access to answer questions. In yet another alternative embodiment, QA program 112 may access network 102 and any knowledge bases found on other devices (not shown) to answer questions. In an embodiment, the knowledge base may be in English. In an alternative embodiment, the knowledge base may be in any language, known in the art. For example, the knowledge base may include nouns, verbs, adjectives, and adverbs that are grouped into sets of cognitive synonyms, each expressing a distinct concept. In an embodiment, the knowledge base may include metadata information about words in the knowledge base such as relationship information between words in the knowledge base.

In an embodiment, the information regarding data mining operations may include any number of data mining operations along with well-defined interfaces of the data operations. The available data mining operations include, but are not limited to, classification, clustering, regression and correlation. Each data operation may include input data requirements for the operation and an output type. For example, the input data may be more than one data points on a graph and the output type may be a graph (i.e. bar graph, correlation graph, a regression line on a graph, etc.) In another example, the input type may be data points with similarity between two data points and the output type may be clustering to identify groups of data points in the data. In yet another example, the input type may be data points that take numerical values with respect to time.

Information repository 114 may be implemented using any volatile or non-volatile storage media for storing information, as known in the art. For example, information repository 114 may be implemented with a tape library, optical library, one or more independent hard disk drives, or multiple hard disk drives in a redundant array of independent disks (RAID). Similarly, information repository 114 may be implemented with any suitable storage architecture known in the art, such as a relational database, an object-oriented database, or one or more tables.

FIG. 2 is a flowchart of workflow 200 depicting operational steps for question answering using natural language processing that includes data mining capabilities, in accordance with an embodiment of the present invention. In one embodiment, the steps of the workflow are performed by QA program 112. Alternatively, steps of the workflow can be performed by any other program while working with QA program 112. In an embodiment, QA program 112 can invoke workflow 200 upon receiving a question from a user. A user, via the user interface discussed previously, can change, edit or modify any aspects of information repository 114 at any time or during any step of workflow 200.

QA program 112 receives a question (step 205). In an embodiment, QA program 112 receives a question from a user, via the user interface discussed previously. In an alternative embodiment, QA program 112 receives a question from a user on another computing device (not shown) connected to computing device 110 via network 102. In an embodiment, QA program 112 receives the question that is worded in a natural language from the user. For example, QA program 112 receives from the user the question, “Are the sales of wines and diapers correlated?”. In another example, QA program 112 receives from the user the question, “What are the segments of the products whose sales are correlated with sales of detergents?” In yet another example, QA program 112 receives from the user the question, “What was the average price of an ounce of gold in January of 1983?” In an embodiment, QA program 112 may determine whether the question has been previously answered, and if so, QA program 112 may retrieve the answer from information repository 114.

QA program 112 answers the question using the textual corpus (step 210). In other words, QA program 112 attempts to find an answer to the question using the unstructured data or textual corpus found in information repository 114. QA program 112 determines if the answer to the question is directly or indirectly answered in the textual corpus. For example, QA program 112 cannot answer the question, “Are the sales of wine and diapers correlated?”, from the textual corpus because there is no mention, either direct or indirect, of any correlation related to wine and diapers in the corpus. In another example, QA program 112 answers the question, “What are the segments of the products whose sales are correlated with sales of detergents?”, by finding an indirect mention in a document of the textual corpus that states “Bleach is generally correlated with the sales of detergents.” In yet another example, QA program 112 answers the question “What was the average price of gold in January of 1983?”, by find a direct mention in a document listing gold prices that states “Gold was $481.29 per ounce in January of 1983.”

QA program 112 determines if the answer has an acceptable confidence level (decision block 215). In an embodiment, QA program 112 may receive a confidence level requirement for an answer associated with the question when the question is received. In an alternative embodiment, QA program 112 may have a confidence level requirement for all answers to any questions that QA program 112 is returning an answer. In an example, QA program 112 was not able to return an answer to the question, “Are the sales of wine and diapers correlated?”, and therefore the lack of an answer means that the answer does not have an acceptable confidence level. In another example, QA program 112 returned the answer, “Bleach is generally correlated with the sales of detergents,” to the question, “What are the segments of the products whose sales are correlated with sales of detergents?” but the answer does not indicate that Bleach is the only segments of the products whose sales are correlated with sales of detergents and therefore the answer is possibly incomplete and the answer does not have an acceptable confidence level. In yet another example, QA program 112 returned the answer, “Gold was $481.29 per ounce in January of 1983,” to the question, “What was the average price of gold in January of 1983?” and the question is directly answered therefore it has an acceptable confidence level. In an embodiment, the confidence level may be compared to a threshold and if the answer has a confidence level higher than the threshold the answer is acceptable and if the answer has a confidence level lower than the threshold the answer is unacceptable. If QA program 112 determined the answer has an acceptable confidence level (decision block 215, yes branch), QA program presents the answer (step 235).

If QA program 112 determines the answer does not have an acceptable confidence level (decision block 215, no branch), QA program 112 maps the question to a data mining (DM) model (step 220). In other words, QA program 112 determines the DM model to apply to the question received to determine the answer. In an embodiment, the DM model may be one or more data mining operations, discussed previously. In an embodiment, QA program 112 may determine the lexical answer type (LAT) of the question. The LAT is the type of answer to the question. In an embodiment, The LAT is used to determine the DM model to map the question to. In an embodiment, the words of the question, the focus of the question, and the entities of the question may also be used to map the question to the DM model. For example, the question, “Are the sales of wine and diapers correlated?”, QA program 112 determines that the LAT is a correlation between wine and diapers and therefore QA program 112 determines the question should be mapped to a “correlation” model. The answer may be an indication of “yes” or “no” regarding the correlation between wine and diapers. Alternatively, the answer may be a graph showing data points and a line indicating any correlation between wine and diapers and the user may determine the correlation. In another example, the question, “What are the segments of products whose sales are correlated with the sales of detergents?”, QA program 112 determines that the LAT is a correlation and clustering and therefore QA program 112 determines the question should be mapped to both a “correlation” model and a “clustering” model.

QA program 112 creates and executes the query (step 225). QA program 112 extracts information from the question related to the determined DM model. In an embodiment, QA program 112 may identify named entities in the question that allows QA program 112 to later associate qualifiers to the corresponding named entities. For example, “How tall is the fastest U.S. Athlete?”, has the qualifier “fastest” associated with the named entity “U.S. Athlete.” In an embodiment, QA program 112 may strip the question of all qualifiers and data mining operation indications but retain the semantic meaning of the question. In an embodiment, QA program 112 may use structured query language or online analytical processing to analyze the question and determine the input to the DM model. In an embodiment, QA program 112 creates a query from the information extracted from the question. For example, the question, “Are the sales of wine and diapers correlated?”, data mining is required for wine and diapers. The adjective related to wines is sales and the adjective related to diapers is sales. The data related to wine and diapers is compared and it is determined if there a correlation. In the example, using the programming language “R”, the following input would be queried, “corr(sales(wines), sales(diapers))”. In another example, the question, “What are the segments of products whose sales are correlated with sales of detergents?” data mining is required for the sales of detergents and the sales of other products. The adjective related to products is segments of products. In the example, using the programming language “R”, the following input would be queried, “corr(sales(X), sales (detergents)) for all X. In an embodiment, QA program 112 executes the query that is created and answers the query using the structured data. In an alternative embodiment, QA program 112 executes the query that is created and answers the query using the structured and unstructured data

QA program 112 transforms the results (step 230). QA program 112 receives the output result from the DM model based on the input query along with the structured and unstructured data. QA program 112 then transforms the output result into the LAT. For example, for the question, “Are the sales of wine and diapers correlated?”, QA program 112 receives the data points related to the sales of wines and the sales of diapers, determines if the correlation is great than a threshold, and if the correlation is greater than a threshold, QA program 112 determines that the sales are correlated. In another example, for the question, “What are the segments of products whose sales are correlated with the sales of detergents?”, QA program 112 receives the data points related to the sales of detergents and the sales of other products. QA program 112 determines if a segment of the sales of other products is above a threshold when compared to the sales of detergents then there is a correlation.

QA program 112 presents the answer (step 235). In an embodiment, QA program 112 presents the answer to the question to the user. In an embodiment, QA program 112 may determine the input question contains a requirement for presenting the answer in the form of a particular visualization. For example, for the question, “What was the average price of gold in January of 1983?”, QA program 112 may present the following statement to the user “Gold was $481.29 per ounce in January of 1983.” In another example, for the question, “Are the sales of wines and diapers correlated?”, QA program 112 may say, “Yes.”. In yet another example, for the question, “what are the segments of products whose sales are correlated with sales of detergents?”, QA program 112 may present a graph showing data points of sales for detergents and multiple other products and the user can make the visual determination if there are correlations between detergents and segments of other products.

FIG. 3 depicts computer 300 that is an example of a computing system that includes QA Program 112. Computer 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for question answering with data mining capabilities, the method comprising the steps of:
receiving, by one or more computer processors, a question, wherein the question is in a natural language;
responsive to receiving the question, determining, by one or more computer processors, whether the question was previously answered;
responsive to determining the question was previously answered, displaying, by one or more computer processors, the previous answer;
responsive to determining the question was not previously answered, determining, by one or more computer processors, an answer to the question using a textual corpus, wherein the textual corpus is a dataset of unstructured data;
determining, by one or more computer processors, the answer has a confidence level below a threshold;
in response to determining the answer has a confidence level below a threshold, mapping, by one or more computer processors, the question to a data mining model;
determining, by one or more computer processors, a query associated with the question, wherein the query is related to the data mining model; and
executing, by one or more computer processors, the query on a dataset of structured data.

2. The method of claim 1, wherein mapping the question to a data mining model comprises:
determining, by one or more computer processors, information about the question, wherein the information includes one or more of the following: a lexical answer type, a focus of the question, one or more entities of the question; and
mapping, by one or more computer processors, the question to a dating mining model based, at least in part on, the information.

3. (canceled)

4. The method of claim 2, further comprising:
in response to executing the query, receiving, by one or more computer processors, a result; and
transforming, by one or more computer processors, the result into an answer based on the information.

5. The method of claim 1, wherein the data mining model is one or more of a classification operation, clustering operation, regression operation, and correlation operation.

6. The method of claim 4, wherein the result is transformed into a graph.

7. A computer program product for question answering with data mining capabilities, the computer program product comprising:
one or more computer readable storage media; and
program instructions stored on the one or more computer readable storage media, the program instructions comprising:
program instructions to receiving a question, wherein the question is in a natural language;
program instructions to, responsive to receiving the question, determine whether the question was previously answered;
program instructions to, responsive to determining the question was previously answered, display the previous answer;
program instructions to, responsive to determining the question was not previously answered, determine an answer to the question using a textual corpus, wherein the textual corpus is a dataset of unstructured data;
program instructions to determine the answer has a confidence level below a threshold;
program instructions to, responsive to determining the answer has a confidence level below the threshold, map the question to a data mining model;
program instructions to determine a query associated with the question, wherein the query is related to the data mining model; and
program instructions to execute the query on a dataset of structured data.

8. The computer program product of claim 7, wherein the program instructions to map the question to a data mining model comprises:
program instructions to determine information about the question, wherein the information includes one or more of the following: a lexical answer type, a focus of the question, one or more entities of the question; and
program instructions to map the question to a data mining model based, at least in part on, the information.

9. (canceled)

10. The computer program product of claim 8, further comprising program instructions, stored on the one or more computer readable storage media, to:
in response to executing the query, receive a result; and
transform the result into an answer based on the information.

11. The computer program product of claim 7, wherein the data mining model is one or more of a classification operation, clustering operation, regression operation, and correlation operation.

12. The computer program product of claim 10, wherein the result is transformed into a graph.

13. A computer system for question answering with data mining capabilities, the computer system comprising:
one or more computer processors;
one or more computer readable storage media; and
program instructions, stored on the one or more computer readable storage media for execution by at least one of the one or more computer processors, the program instructions comprising:
program instructions to receiving a question, wherein the question is in a natural language;
program instructions to, responsive to receiving the question, determine whether the question was previously answered;
program instructions to, responsive to determining the question was previously answered, display the previous answer;
program instructions to, responsive to determining the question was not previously answered, determine an answer to the question using a textual corpus, wherein the textual corpus is a dataset of unstructured data;
program instructions to determine the answer has a confidence level below a threshold;
program instructions to, responsive to determining the answer has a confidence level below the threshold, map the question to a data mining model;
program instructions to determine a query associated with the question, wherein the query is related to the data mining model; and
program instructions to execute the query on a dataset of structured data.

14. The system of claim 13, wherein the program instructions to map the question to a data mining model comprises:
program instructions to determine information about the question, wherein the information includes one or more of the following: a lexical answer type, a focus of the question, one or more entities of the question; and
program instructions to map the question to a data mining model based, at least in part on, the information.

15. (canceled)

16. The computer system of claim 14, further comprising program instructions, stored on the one or more computer readable storage media for execution by at least one of the one or more computer processors, to:
in response to executing the query, receive a result; and
transform the result into an answer based on the information.

17. The computer system of claim 13, wherein the data mining model is one or more of a classification operation, clustering operation, regression operation, and correlation operation.

18. The computer system of claim 16, wherein the result is transformed into a graph.
